(19) United States
(12) Patent Application Publication
(10) Pub. No.: US 2010/0020113 A1
(43) Pub. Date: Jan. 28, 2010

(54) ELECTRONIC DISPLAY MODULE AND DISPLAYING METHOD THEREOF

(76) Inventor: Chun-Hui TSAI, Hsin-chu city (TW)

Correspondence Address: SINORICA, LLC, 2275 Research Blvd., Suite 500, ROCKVILLE, MD, 20850, US

(21) Appl. No.: 12/496,626

(22) Filed: Jul. 1, 2009

(30) Foreign Application Priority Data
Jul. 24, 2008 (TW) 097128053

(51) Int. Cl. G06F 3/038; G09G 5/10

(52) U.S. Cl. 345/690; 345/213

(57) ABSTRACT

The present invention provides an electronic display module and displaying method thereof. The electronic display module includes a light source, a filter and a light valve. The electronic display module further has a display panel with a plurality of display regions for displaying an image. The electronic display module is provided to adjust the light intensity by space and time varying luminance of the light source, so as to enable the electronic display module to present the image in dynamic display according to the space and time varying approach.

### BACKGROUND OF THE INVENTION

1. Field of the Invention

The present invention is related to an electronic display module and method thereof, and more particularly is related to a electronic display module and method by using a space varying method and a time varying method to present an image in dynamic display.

2. Description of the Prior Art

In prior art, the image dynamic display is to present an image by a space varying method, and U.S. Pat. No. 7,064,740 disclosed an image dynamic display method, as shown in FIG. 1A. The backlit display 10 includes a backlit board 12, a filter 14 and a light valve 16. The light valve 16 is adjusted by spatially varying the light source 13. Therefore, the light 15 for the image illumination can be controlled, and the pixels 19 of the image is being dynamically presented on the display panel 18. The image includes a number of horizontal and vertical pixels to present the content of the image, and the light source 13 is disposed behind the pixels 19. However, a partial region in the display panel 18 is needed to be dark, but the nonzero luminance light source is still required for provision.

In addition, U.S. Pat. No. 5,717,422 and No. 6,816,141 disclosed a display system, as shown in FIG. 1B. The display system 1 includes a light source 2, a liquid crystal display (LCD) module 3, an optical module 4, a control unit 5, an image signal source 6 and a light sensor 7. The control unit 5 will provide a different luminance for the LCD module 3 in accordance with the image content provided by the image signal source 6 and the illumination of the environment is detected by the light sensor 7, and controls the pixels in the LCD module 3. The image projected from the optical module 4 will be shown in a better illumination and contrast so as to have a better image dynamic display. However, the prior art described above will have a problem that the illumination of image is not good enough when the light source 2 is controlled to provide the illumination for the LCD module 3.

### SUMMARY OF THE INVENTION

In order to solve the drawbacks in the prior art, an electronic display module and displaying method of the electronic display module is disclosed herein. The electronic display module is provided to display an image, and the electronic display module includes a light source, a filter and a light valve, and the electronic display module including a plurality of display regions to display the image which includes a plurality of horizontal and vertical pixels to illuminate the content of the image and the light source is disposed behind the pixels. The electronic display module is provided to adjust the light intensity of the light source by a space varying method and a time varying method; wherein the space varying method is to utilize the filter and change the light transmission of the light valve to form the uniform-distributed image in accordance with the uniform distributed illumination profile of the light source. In addition, the time varying method is to generate a plurality of horizontal clock signals (H₁, H₂, . . . ,Hₘ) and a plurality of vertical clock signals(V₁, V ₂, . . . ,Vₙ), wherein each horizontal clock signal has a nonzero luminance, and the nonzero luminance of each horizontal clock signal does not overlap to each other, and each vertical clock signal controls the light intensity corresponding to each display region of the image. Therefore, the electronic display module can present the image in dynamic display in accordance with the space and time varying methods.

Therefore, the first object of the present invention is to provide an electronic display module in which the time varying method is provided to adjust the illumination of the light source. The time varying method is configured to generate a plurality of horizontal clock signals (H1, H2, . . . ,Hm) and a plurality of vertical clock signals(V1, V2, . . . ,Vn), wherein each of the horizontal clock signals in its nonzero luminance has a less than or equal to 25% clock width and each in its zero luminance has a more than or equal to 75% clock width such that power consumption of the electronic display module can be improved significantly.

The second object of the present invention is to provide an electronic display module used to adjust the illumination of the light source so as to present the image in dynamic display by means of the space varying method and the time varying method.

The third object of the present invention is to provide a displaying method and use a space varying method and a time varying method to adjust the illumination of the light source. The time varying method is configured to generate a plurality of horizontal clock signals (H1, H2, . . . ,Hm) and a plurality of vertical clock signals(V1, V2, . . . ,Vn), wherein each of the horizontal clock signals in its nonzero luminance has a less than or equal to 25% clock width and each in its zero luminance has a more than or equal to 75% clock width such that power consumption of the electronic display module can be improved significantly.

The fourth object of the present invention is to provide a displaying method used to adjust the illumination of the light source to present the image in dynamic display by means of a space varying method and a time varying method.

The fifth object of the present invention is to provide an electronic display module in which the time varying method is provided to adjust the illumination of the light source. The time varying method is configured to generate a horizontal clock signal H1 and a vertical clock signal V1, wherein the horizontal clock signal in its nonzero luminance has a less than or equal to 25% clock width and each in its zero luminance has a more than or equal to 75% clock width such that power consumption of the electronic display module can be improved significantly.

The sixth object of the present invention is to provide a displaying method and use a space varying method and a time varying method to adjust the illumination of the light source. The time varying method is configured to generate a horizontal clock signal H1 and a vertical clock signal V1, wherein the horizontal clock signal in its nonzero luminance has a less than or equal to 25% clock width and that in its zero luminance has a more than or equal to 75% clock width such that power consumption of the electronic display module can be improved significantly.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a schematic view illustrating an image dynamic display in prior art;

FIG. 1B is a schematic view illustrating another image dynamic display in prior art;

FIG. 2 is a block diagram illustrating the display in the present invention;

FIG. 3 is a schematic circuit view illustrating the scan unit and the micro processor in the present invention;

FIG. 4 is a clock signal diagram illustrating the clock operation in the scan unit and the micro processor in the present invention; and

FIG. 5 is a schematic view illustrating the Mercury Free Flat Fluorescent Lamp for the light source in the present invention.

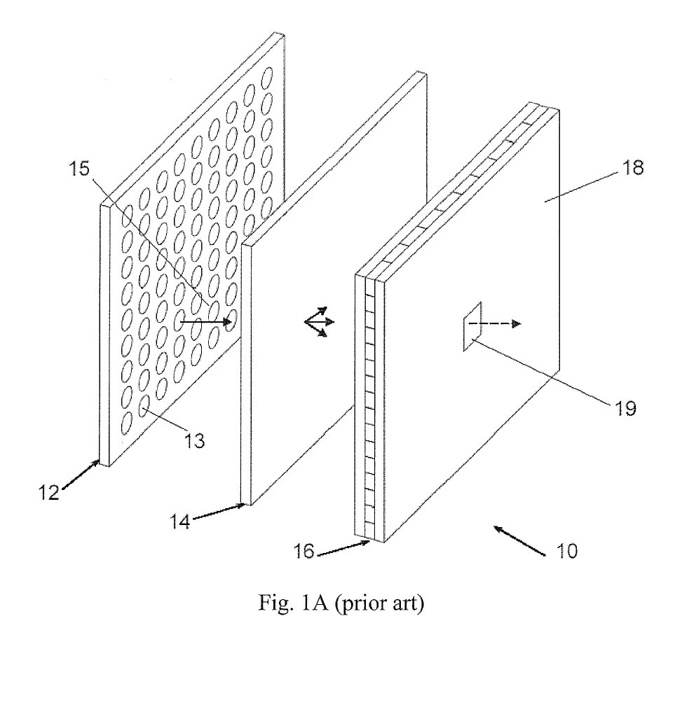

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

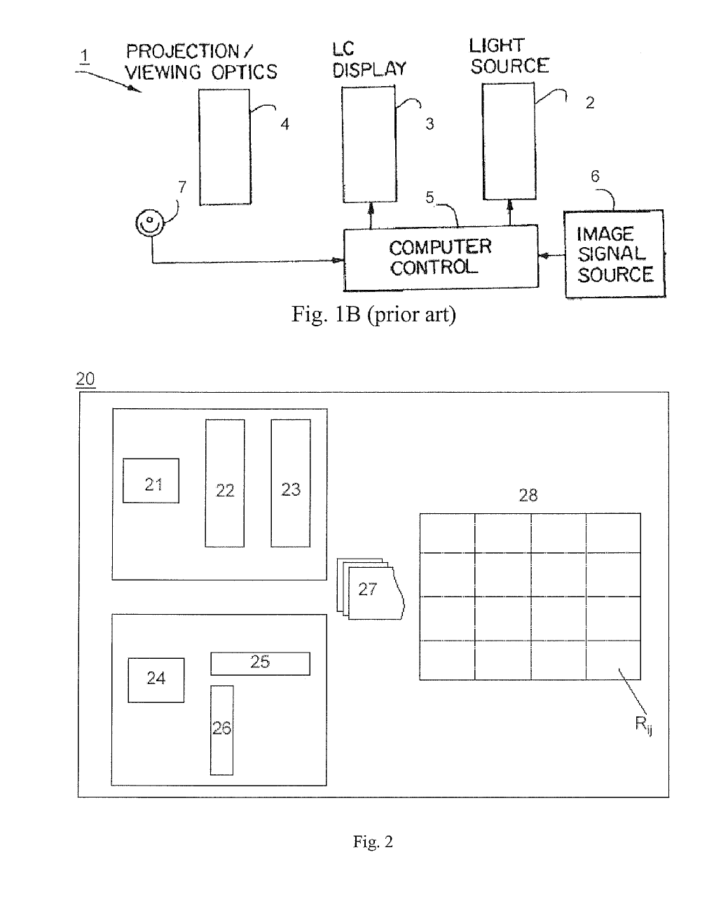

FIG. 2 is a block diagram for showing an electronic display module 20 in a first embodiment of the present invention. The electronic display module 20 is used to display an image 27 and the electronic display module 20 includes a light source 21, a filter 22 and a light valve 23. The electronic display module 20 has a display panel 28 that is constituted by several display regions Rᵢⱼ to present the image 27. The image 27 is constituted by a number of horizontal and vertical pixels to present the content of the image 27. The light source 21 is disposed behind the pixels. The electronic display module 20 will adjust the illumination of the light source 21 by means of a space varying method and a time varying method in accordance with the pixels of the image 27. Particularly, the electronic display module 20 further utilizes the space varying method to present the image 27 in uniformed distribution on the display panel 28 by means of using the filter 22 and changing the light transmission of the light valve 23 to adjust the non-uniform distributed illumination profile of the light source 21.

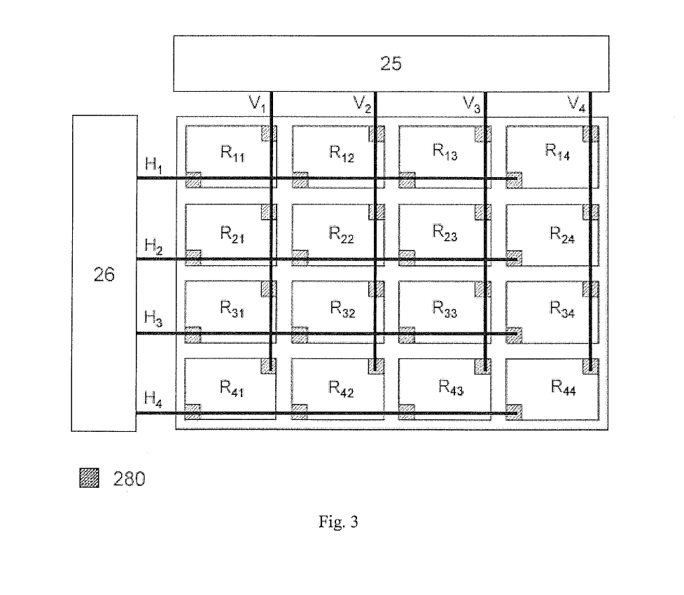

In addition, the display 20 further includes a control circuit 24 that utilizes the time varying method to control the illumination of the display regions Rᵢⱼ in the display panel 28. Moreover, the control circuit 24 will determine which display regions Rᵢⱼ are needed to illuminate and how much the light source intensity is required to lighten the display regions Rᵢⱼ according to the content of the image 27 and the clock signals. Therefore, the control circuit 24 further includes a scan unit 26 and a micro processor 25 for generating a number m of horizontal clock signals (H₁,H₂, . . . ,Hₘ) and a number n of vertical clock signals (V₁,V₂, . . . ,Vₙ). Each of the horizontal clock signals is responsible for scanning (or lightening) each horizontal row of the display regions and each of the vertical clock signals will determine the light intensity corresponding to each scanned display region in the particular horizontal row. Therefore, there are total of m*n display regions Rᵢⱼ in the display panel 28, where i=1, . . . ,m and j=1, . . . ,n, as shown in FIG. 3 (m=4 and n=4). Each of the display regions Rᵢⱼ is respectively connected to a horizontal clock signal Hi of the scanning unit 26 and a vertical clock signal Vj of the micro processor 25 through a cross-connection portion 280, so as to control the light intensity in each of the display regions Rᵢⱼ.

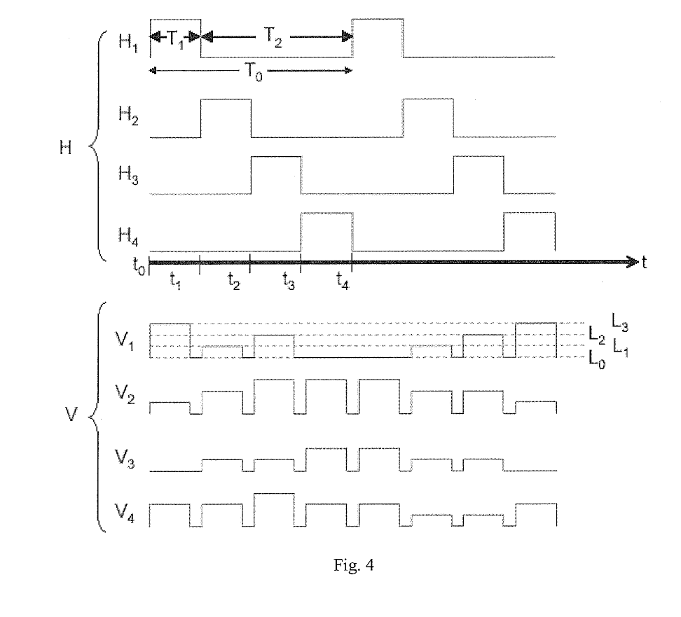

In the above-mentioned embodiment, the vertical signal includes four different amplitude levels, and they are L₀(full dark), L₁(½ brightness), L₂(⅔ brightness) and L₃(full brightness), as shown in FIG. 4. Please referred back to FIGS. 2-3, the control circuit 24 is used to drive the scan unit 26 so as to generate four horizontal clock signals (H₁, H₂, H₃ and H₄) and to drive the micro processor 25 so as to generate four vertical clock signals (V₁, V₂, V₃ and V₄). The horizontal clock signals (H₁, H₂, H₃ and H₄) respectively include a clock period with a clock width T₀. T₀ is constituted by a clock width T₁ and a clock width T₂. T₁ is the clock width in the nonzero luminance and T₂ is the clock width in the zero luminance. The ratio of T₁ to T₂ is 1:3. Because each horizontal clock signal has T₁ about 25% of T₀ and T₂ about 75% of T₀, it is able to reduce the power consumption for image display. In addition, the horizontal clock signal H₁ controls (or lights up/off) the light source for the first horizontal row of the display regions R₁₁˜R₁₄, the horizontal clock signal H₂ for the second horizontal row of the display regions R₂₁˜R₂₄, the horizontal clock signal H₃ for the third horizontal row of the display regions R₃₁˜R₃₄, and the horizontal clock signal H₄ for the forth horizontal row of the display regions R₄₁˜R₄₄. The vertical clock signal V₁ controls the light source intensity for the first vertical column of the display regions R₁₁˜R₄₁, the second vertical clock signal V₂ for the second vertical column of the display region R₁₂˜R₄₂, the vertical clock signal V₃ for the third vertical column of the display region R₁₃˜R₄₃, and the vertical clock signal V₄ for the fourth vertical column of the display region R₁₄˜R₄₄.

Now referring back to FIG. 4, the following steps are provided to describe how the control circuit 24 drives the scan unit 26 and the micro processor 25 to control the scanning and the illumination intensity of the image:
(1) At the initial time to, as the control circuit 24 receives the images 27, the control circuit 24 will drive the scan unit 26 and the micro processor 25 at the same time.
(2) In the time interval t₁, the scan unit 26 will send out four horizontal clock signals H₁, H₂, H₃, H₄ into the display region Rᵢⱼ of the display panel 28. Only the horizontal clock signal H₁ is nonzero trigger (or light-on), and the rest of the horizontal clock signals H₂, H₃ and H₄ are zero trigger (or light-off). Therefore, only the first row R₁₁˜R₁₄ is triggered. The micro processor 25 will send out four vertical clock signals V₁, V₂, V₃ and V₄ into the display region Rᵢⱼ of the display panel 28 where V₁ is L₃(full brightness), V₂ is L₂(half brightness), V₃ is L₄(full dark) and V₄ is L₃(⅔ brightness). Therefore, the triggered display region R₁₁ will be in the full brightness condition, R₁₂ will be in the half brightness condition R₁₃ will be in the full dark condition and R₁₄ will be in the half brightness condition R₁₃ will be in the ⅔ brightness condition.
(3) In the time interval t₂, the scan unit 26 will send out four horizontal clock signals H₁, H₂, H₃, H₄ into the display region Rᵢⱼ of the display panel 28. Only the horizontal clock signal H₂ is nonzero trigger, and the rest of the horizontal clock signals H₁, H₃ and H₄ are zero trigger. Therefore, only the second row R₂₁˜R₂₄ is triggered. The micro processor 25 will send out four vertical clock signals V₁, V₂, V₃ and V₄ into the display region Rᵢⱼ of the display panel 28 where V₁ is L₁(half brightness), V₂ is L₂(⅔ brightness), V₃ is L₁(half brightness) and V₄ is L₂(⅔ brightness). The triggered display region R₂₁ will be in the half brightness condition, R₂₂ will be in the ⅔ brightness condition, R₂₃ will be in the half brightness condition and R₂₄ will be in the ⅔ brightness condition.
(4) In the time interval t₃, the scan unit 26 will send out four horizontal clock signals H₁, H₂, H₃, H₄ into the display region Rᵢⱼ of the display panel 28. Only the horizontal clock signal H₃ is nonzero trigger, and the rest of the horizontal clock signals H₁, H₂ and H₄ are zero trigger. Therefore, only the third row R₃₁˜R₃₄ is triggered. The micro processor 25 will send out four vertical clock signals V₁, V₂, V₃ and V₄ into the display region Rᵢⱼ of the display panel 28 where V₁ is L₂(⅔ brightness), V₂ is L₃(full brightness), V₃ is L₂(half brightness) and V₄ is L₃(full brightness). The triggered display region R₃₁ will be in the ⅔ brightness condition, R₃₂ will be in the full brightness condition, R₃₃ will be in the half brightness condition and R₃₄ will be in the full brightness condition.
(5) In the time interval t₄, the scan unit 26 will send out four horizontal clock signals H₁, H₂, H₃, H₄ into the display region Rᵢⱼ of the display panel 28. Only the horizontal clock signal H₄ is nonzero trigger, and the rest of the horizontal clock signals H₁, H₂ and H₃ are zero trigger. Therefore, only the third row R₄₁˜R₄₄ is triggered. The micro processor 25 will send out four vertical clock signals V₁, V₂, V₃ and V₄ ito the display region Rᵢⱼ of the display panel 28 where V₁ is L₂(half brightness), V₂ is L₃(⅔ brightness), V₃ is L₂(half brightness) and V₄ is L₃(⅔ brightness). The triggered display region R₄₁ will be in the half brightness condition, R₄₂ will be in the ⅔ brightness condition, R₄₃ will be in the half brightness condition and R₄₄ will be in the ⅔ brightness condition.

In the above-mentioned embodiment, the period To of the horizontal clock signal is equal to the signal length of one image 27. After the time interval t₄, the horizontal clock signal will start the next period T₀ for another image and the previous steps are repeated. In addition, the nonzero luminance in each of the horizontal clock signal is not overlapped and each of the vertical clock signals will control the light source intensity for the corresponding image.

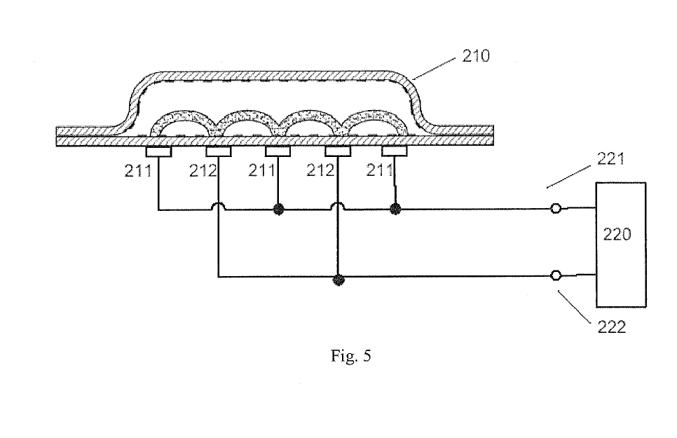

In the above-mentioned embodiment, the light source 21 is a Mercury Free Flat Fluorescent Lamp (FFL) 210, as shown in FIG. 5. The FFL 210 can be stand alone or arranged in array. The positive electrode 211 and the negative electrode 212 are used to generate light source by high voltage discharge. The FFL 210 is connected to two terminal ends 221 and 222 of an AC power source 220, and the AC power source 220 includes a plurality of voltage pulses in a sequence where the voltage pulse is a half-sine wave. The voltage pulse has a pulse frequency ranging from 1K Hz to 1M Hz, and has a preferred frequency ranging from 10K Hz to 100K Hz with 100 V-10K V pulse amplitude. In addition, the voltage pulse has a pulse width ranging from 0.1 μs to 10 μs, and has a preferred pulse width ranging from 0.5 μs to 5 μs. In addition, a time pause is spaced between the voltage pulses, and the time pause is between 5 μs and 100 μs.

In the above-mentioned embodiment, when m=n=1, the electronic display module 20 will present the image by means of a single light source region. In other words, the light source will not be necessary to be controlled by the control circuit because there is only one display region to display the image. Similarly, the image is constituted by controlling its pixels by the light valve so as to display the image content.

The second embodiment of the present invention is also disclosed herein. It is a displaying method provided in an electronic display module for presenting an image, and the method includes the following steps:
(1) providing an electronic display module that includes a light source, a filter and a light valve;
(2) implementing a space varying method to form the image having a uniform light distribution by means of controlling the filter and light transmission of the light valve together with a non-uniform distributed illumination profile of the light source;
(3) implementing a time varying method to generate a plurality of horizontal clock signals (H1, H2, . . . , Hm) and a plurality of vertical clock signals (V1, V 2, . . . , Vn) wherein each of the horizontal clock signals has a nonzero luminance not overlapped to each other, and wherein each of the vertical clock signals controls the light intensity corresponding to each display region of the image; and
(4) providing a control circuit to implement the time varying method so as to generate the horizontal and the vertical clock signals such that the electronic display module can present the image in dynamic display.

In the second embodiment, the electronic display module includes a number of horizontal and vertical display regions in its display panel to display the image and the pixels of the image will present the content. The light source is disposed behind the pixels of the image, and the pixels of the image will display the content.

In the second embodiment, the structural characteristics and the display operation of the electronic display module, the light source, the filter, the light valve, the control circuit, the scan unit, the micro processor, the horizontal clock signal and the vertical clock signal are the same as the first embodiment.

Although specific embodiments have been illustrated and described, it will be appreciated by those skilled in the art that various modifications may be made without departing from the scope of the present invention, which is intended to be limited solely by the appended claims.

What is claimed is:

1. An electronic display module, provided to display an image, comprising a light source, a filter and a light valve, and the electronic display module having a plurality of display regions to display the image with a plurality of pixels to illuminate content of the image, and the light source being disposed behind the pixels, characterized in that:
the electronic display module adjusts light intensity of the light source base on a space varying method and a time varying method; wherein
the space varying method is configured to form the image having a uniform light distribution by means of controlling the filter and light transmission of the light valve together with a non-uniform distributed illumination profile of the light source; and
the time varying method is configured to generate a plurality of horizontal clock signals (H1, H 2, . . . ,Hm) and a plurality of vertical clock signals(V1, V 2, . . . ,Vn) wherein each of the horizontal clock signals has a nonzero luminance not overlapped to each other, and wherein each of the vertical clock signals controls the light intensity corresponding to each display region of the image, so as to allow the electronic display module to present the image in dynamic display in accordance with the space and time varying methods.

2. The electronic display module according to claim 1, further comprising a control circuit to generate the horizontal clock signals and the vertical clock signals.

3. The electronic display module according to claim 2, wherein the number m of horizontal clock signals and the number n of the vertical clock signal have a product value equal to the number (m*n) of total display regions in the electronic display module.

4. The electronic display module of claim 2, wherein each of the horizontal clock signals in its nonzero luminance has a less than or equal to 25% clock width and each in its zero luminance has a more than or equal to 75% clock width.

5. The electronic display module according to claim 1, wherein the light source is a Mercury Free Flat Fluorescent Lamp (FFL).

6. The electronic display module according to claim 5, wherein the light source further comprises an AC power source having a plurality of voltage pulses in a sequence.

7. The electronic display module according to claim 6, wherein the voltage pulse has a pulse width ranging from 0.1 μs to 10 μs.

8. The electronic display module according to claim 7, wherein the voltage pulse has a preferred pulse width ranging from 0.5 μs to 5 μs.

9. The electronic display module according to claim 6, wherein the voltage pulse has a pulse frequency ranging from 1K Hz to 1M Hz.

10. The electronic display module according to claim 9, wherein the voltage pulse has a preferred frequency ranging from 10K Hz to 100K Hz.

11. The electronic display module according to claim 6, wherein the voltage pulse is a half-sine wave.

12. The electronic display module according to claim 6, wherein the voltage pulse has a pulse amplitude ranging from 100V to 10KV.

13. A displaying method, used to display an image, comprising:
providing an electronic display module that includes a light source, a filter and a light valve;
implementing a space varying method to form the image having a uniform light distribution by means of controlling the filter and light transmission of the light valve together with a non-uniform distributed illumination profile of the light source;
implementing a time varying method to generate a plurality of horizontal clock signals (H1, H2, . . . , Hm) and a plurality of vertical clock signals (V1, V 2, . . . , Vn) wherein each of the horizontal clock signals has a nonzero luminance not overlapped to each other, and wherein each of the vertical clock signals controls the light intensity corresponding to each display region of the image; and
providing a control circuit to generate the horizontal and the vertical clock signals, so as to allow the electronic display module to present the image in dynamic display.

14. An electronic display module, provided to display an image, comprising a light source, a filter and a light valve, the electronic display module having a display region to display the image with a plurality of pixels to illuminate content of the image, and the light source being disposed behind the pixels, wherein
the electronic display module adjusts light intensity of the light source based on a space varying method and a time varying method; wherein
the space varying method is configured to form the image having a uniform light distribution by means of controlling the filter and light transmission of the light valve together with a non-uniform distributed illumination profile of the light source; and wherein
the time vary method is configured to generate a horizontal clock signal H1 and a vertical clock signal V1 wherein the horizontal clock signal has a nonzero luminance not overlapped to each other, and the vertical clock signal controls the light intensity corresponding to the display region of the image, so as to allow the electronic display module to present the image in dynamic display in accordance with the space and time varying methods.

15. The display according to claim 14, further comprising a control circuit to generate the horizontal signal and vertical clock signal.

16. The display according to claim 14, wherein the number of the horizontal clock signal and the number of the vertical clock signal have a product value equal to one (1*1) display region of the electronic display module.
